(19) United States
(12) Patent Application Publication
(10) Pub. No.: US 2024/0005083 A1
(43) Pub. Date: Jan. 4, 2024

(54) METHOD AND SYSTEM FOR MERGING PDF FILES IN A LARGE BATCH

(71) Applicant: Fujian Foxit Software Development Joint Stock Co., Ltd., Fuzhou, Fujian (CN)

(72) Inventor: Junyi LIANG, Fuzhou, Fujian (CN)

(21) Appl. No.: 18/035,161

(22) PCT Filed: Mar. 30, 2022
(86) PCT No.: PCT/CN2022/000057

§ 371 Date: May 3, 2023

(30) Foreign Application Priority Data
Apr. 19, 2021 (CN) 202110419112.0

(51) Int. Cl. G06F 40/131; G06F 40/157; G06F 40/103

(52) U.S. Cl. CPC G06F 40/131; G06F 40/157; G06F 40/103

(57) ABSTRACT

Disclosed are a method and system for merging a large batch of PDF files. The method comprises: outputting header information of a target PDF file, outputting catalog dictionary information, and generating an object number of a PDF page object and recording same; parsing in sequence PDF files to be merged, and acquiring the object number and the offset of all indirect objects and the catalog dictionary information; parsing in sequence, from within the catalog dictionary information, page object dictionary information corresponding to the PDF files to be merged, and reading in sequence object number information of each page object; invoking a global object number generator to generate a new object number, and recording the correspondence between original object number information and the new object number in a map; invoking an output class of a PDF indirect object, outputting a page object of the PDF files to be merged into a page object of the target PDF file, and recording same in the start position and length in the target PDF file; and checking whether all PDF files to be merged have completed merging.

### TECHNICAL FIELD

The invention relates to the field of computer technology, and in particular to the processing of PDF files in a computer, more particularly a method and system for merging PDF files in a large batch.

### BACKGROUND

PDF (Portable Document Format) is a file format developed by Adobe Systems for exchanging files in a way independent of applications, operating systems and hardware. The PDF file is based on the image model of the PostScript language (PS for short, which is a page description language and a programming language mainly used in the electronic industry and the field of desktop publishing), and can ensure precise colors and accurate printing effect on any type of printer, that is, PDF will faithfully reproduce every character, color and image of a manuscript. FIG. 1 is a schematic structural diagram of a PDF file. As shown in FIG. 1, a PDF file usually consists of the following four elements: a header characterizing the version of the PDF specification that the file conforms to; a body containing objects that compose a document contained in the file; a cross-reference table containing information about indirect objects in the file; and a trailer providing positions of some special objects in the cross-reference table and the body.

In the process of using multiple PDF files, a user may need to merge the PDF files. The conventional method for merging PDF files is to parse the PDF files first, then clone (a method of copying objects by a Java program) all contents of the PDF files into a newly generated PDF file, and finally save this newly generated PDF file. Because this method for merging PDF files needs to save the relevant information of the whole merged PDF file in the memory when executed, it will lead to the continuous increase of the program's memory usage, and especially when there are a lot of PDF files to be merged, such a method will occupy a lot of computer memory and take a long time to merge the PDF files at low execution efficiency and also affect the execution of other applications in computation when adopted.

### SUMMARY

In order to solve the aforementioned problems, the present invention provides a method and system for merging PDF files in a large batch, which, by only obtaining the position information of each object in the files from the PDF files to be merged, parse a few pieces of dictionary information, call a global object value generator, modify object values in each PDF file to be merged and then output them into a newly generated PDF file, thus completing the merging of the PDF files in a large batch in a short time with less memory.

In order to achieve the aforementioned objective, the present invention provides a method for merging PDF files in a large batch, which comprises the following steps:
Step 1: determining and outputting header information of a merged target PDF file, outputting corresponding catalog dictionary information, and generating and recording objnums (object numbers) of corresponding PDF pages;
Step 2: sequentially parsing a plurality of PDF files to be merged to obtain objnums and offsets of all indirect objects of each PDF file to be merged as well as catalog dictionary information of each PDF file to be merged;
Step 3: sequentially parsing page dictionary information corresponding to each PDF file to be merged from the catalog dictionary information of the PDF file to be merged, and sequentially reading the objnum information of each page from all the page dictionary information;
Step 4: calling a global objnum generator to generate new objnums, and recording the corresponding relationship between the original objnum information and the new objnums into a map;
Step 5: calling an output class for the PDF indirect objects to output the pages of each PDF file to be merged into pages of the merged target PDF file, and recording their starting positions and lengths in the target PDF file;
Step 6: checking whether all the PDF files to be merged have been merged,
if not, returning to Step 2;
if so, combining global information into the merged target PDF file according to page dictionary information of the target PDF file.

In an embodiment of the present invention, the information parsed from the catalog dictionary information of each PDF file to be merged in Step 3 further comprises AcroForm (interactive form) information and bookmark information corresponding to the PDF file to be merged.

In an embodiment of the present invention, Step 5 specifically comprises:
Step 501: storing all the indirect objects referenced in the page dictionary information of each PDF file to be merged into a vector;
Step 502: circularly outputting all the indirect objects in the vector into the merged target PDF file, and if any output is a parent dictionary of the pages of the PDF file to be merged, using a page of the target PDF file to replace and end the corresponding output;
Step 503: judging whether all the indirect objects have been output,
if so, arranging the page dictionary information of each PDF file to be merged, and recording starting positions and lengths of all the indirect objects in the vector in the merged target PDF file;
if not, returning to Step 3.

In an embodiment of the present invention, in Step 501, the indirect objects of the parent of the pages of each PDF file to be merged are modified into the pages of the merged target PDF file when stored.

In an embodiment of the present invention, the output of any indirect object in Step 502 is performed only once.

In an embodiment of the present invention, the global information combined in Step 6 comprises AcroForm information and bookmark information.

In order to achieve the aforementioned purpose, the present invention further provides a system for merging PDF files in a large batch, which comprises:
a PDFMerger module, configured to manage a merged target PDF file, which comprises objnums of all indirect objects output in the process of PDF merging, offsets of all the indirect objects, and page dictionary information of the target PDF file;
a MergePDFDocument module, configured to manage and parse the PDF files to be merged, and parsed contents comprising the objnums and offsets of all the indirect objects, catalog dictionary information of the PDF files to be merged, all the page dictionary information and AcroForm dictionary information;
a MergePDFPage module, configured to process all the indirect objects to be output in the page dictionaries of the PDF files to be merged; and
a PDFObjnumGenerator module, configured to generate objnums of the indirect objects of the merged target PDF file, and being a global-oriented class module.

Compared with the prior art, the method and system for merging PDF files in a large batch according to the present invention have the following advantages: during the merging of PDF files in a large batch, the time of merging is short, the whole process occupies little system memory, the efficiency of merging is high, and the merging operation does not affect the use of other applications.

### DESCRIPTION OF THE DRAWINGS

In order to more clearly illustrate the technical solution in embodiments of the present invention or the prior art, the accompanying drawings which need to be used in the description of the embodiments or the prior art will be introduced briefly below. Apparently, the accompanying drawings described below are merely some embodiments of the present invention, and those of ordinary skill in the art can also obtain other accompanying drawings according to these drawings without making creative efforts.

FIG. 1 is a schematic structural diagram of a PDF file;

FIG. 2 is a flowchart according to an embodiment of the present invention;

FIG. 3 is an architecture diagram of a system according to an embodiment of the present invention;

FIG. 4 is a time consumption comparison diagram of merging 50 PDF files each time according to an embodiment of the present invention;

FIG. 5 is a memory consumption comparison diagram of merging 50 PDF files each time according to an embodiment of the present invention;

FIG. 6 is a time consumption comparison diagram of merging 200 PDF files each time according to an embodiment of the present invention;

FIG. 7 is a memory consumption comparison diagram of merging 200 PDF files each time according to an embodiment of the present invention;

FIG. 8 is a time consumption comparison diagram of merging 1000 PDF files each time according to an embodiment of the present invention;

FIG. 9 is a memory consumption comparison diagram of merging 1000 PDF files each time according to an embodiment of the present invention;

FIG. 10 is a time consumption comparison diagram of merging 2000 PDF files each time according to an embodiment of the present invention;

FIG. 11 is a memory consumption comparison diagram of merging 2000 PDF files each time according to an embodiment of the present invention.

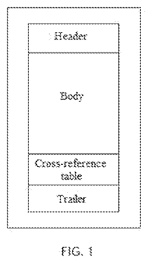

Reference numerals: 10. System for merging large batches of PDF files; 101. PDFMerger module; 102. MergePDFDocument module; 103. MergePDFPage module; 104. PDFObjnumGenerator module.

### DETAILED DESCRIPTION

The technical solution in the embodiments of the present invention will be clearly and completely described below with reference to the drawings in the embodiments of the present invention, and it is obvious that the described embodiments are only a part of the embodiments of the present invention but not all of them. Based on the embodiments of the present invention, all other embodiments obtained by those of ordinary skilled in the art without creative efforts shall fall within the protection scope of the present invention.

### Embodiment 1

FIG. 2 is a flowchart according to an embodiment of the present invention. As shown in FIG. 2, the present embodiment provides a method for merging PDF files in a large batch, which includes the following steps:

Step 1: determining and outputting header information of a merged target PDF file, outputting corresponding catalog dictionary information, and generating and recording objnums of corresponding PDF pages;

Among them, a catalog dictionary is a root of a PDF document object hierarchy which is located by a root entry in a trailer of a PDF file, and is equivalent to a catalog, which contains references to other objects that define document content, an outline, article threads, named destinations, and other attributes; and pages include nodes of a page tree, a root node of the document page tree, and an indirect object.
Step 2: sequentially parsing a plurality of PDF files to be merged to obtain objnums and offsets of all indirect objects of each PDF file to be merged as well as catalog dictionary information of each PDF file to be merged;
Step 3: sequentially parsing page dictionary information corresponding to each PDF file to be merged from the catalog dictionary information of the PDF file to be merged, and sequentially reading the objnum information of each page from all the page dictionary information;

In the present embodiment, the information parsed from the catalog dictionary information of each PDF file to be merged in Step 3 further includes AcroForm information, bookmark information and other information corresponding to the PDF file to be merged.

Step 4: calling a global objnum generator to generate new objnums, and recording the corresponding relationship between the original objnum information and the new objnums into a map;
Step 5: calling an output class for the PDF indirect objects to output the page of each PDF file to be merged into pages of the merged target PDF file, and recording their starting positions and lengths in the target PDF file;

In the present embodiment, Step 5 specifically includes: Step 501: storing all the indirect objects referenced in the page dictionary information of each PDF file to be merged into a vector;

In the present embodiment, in Step 501, the indirect objects of the parent of the pages of each PDF file to be merged are modified into the pages of the merged target PDF file when stored.

Step 502: circularly outputting all the indirect objects in the vector into the merged target PDF file, and if any output is a parent dictionary of the pages of the PDF file to be merged, using a page of the target PDF file to replace and end the corresponding output;
In the present embodiment, all the indirect objects are output only once in Step 502, and during the loop output, it is unnecessary to output the indirect objects again if they have already been output.

Step 503: judging whether all the indirect objects have been output,
if so, arranging the page dictionary information of each PDF file to be merged, and recording starting positions and lengths of all the indirect objects in the vector in the merged target PDF file;
if not, returning to Step 3.

Step 6: checking whether all the PDF files to be merged have been merged, if not, returning to Step 2;
if so, combining global information into the merged target PDF file according to page dictionary information of the target PDF file.

In the present embodiment, the global information combined in Step 6 includes information such as AcroForm information and bookmark information.

### Embodiment 2

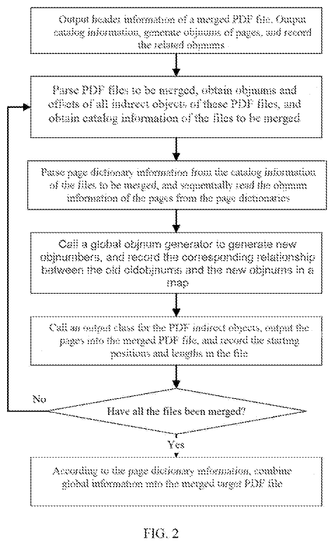

FIG. 3 is an architecture diagram of a system according to an embodiment of the present invention. As shown in FIG. 3, the present embodiment provides a system (10) for merging PDF files in a large batch, which is configured to implement the method of embodiment 1. The system includes:
a PDFMerger module (101), configured to manage a merged target PDF file, which includes objnums of all indirect objects output in the process of PDF merging, offsets of all the indirect objects, and page dictionary information of the target PDF file;
a MergePDFDocument module (102), configured to manage and parse the PDF files to be merged; in the present embodiment, the main function of the MergePDFDocument module (102) is to parse the PDF files to be merged to obtain the objnums and offsets of all the indirect objects in these files and also to parse the catalog dictionaries of the PDF files to be merged to obtain the dictionary information of all the pages, the dictionary information of AcroForms and the like of the corresponding files.
a MergePDFPage module (103), configured to process all the indirect objects to be output in the page dictionaries of the PDF files to be merged; in the present embodiment, all the indirect objects in the page dictionaries are not decompressed in the process of outputting, but are directly output into the merged target PDF file by employing the original compression method in the PDF files to be merged.
a PDFObjnumGenerator module (104), configured to generate objnums of the indirectly referenced objects of the merged target PDF file, and being a global-oriented class module. In the present embodiment, the new objnums of all the objects are uniformly generated by this class module.

### Embodiment 3

In the present embodiment, a test environment was built according to Embodiment 1 and Embodiment 2, and the performance of merging PDF files under different conditions was tested and compared with that of merging the same PDF files with Adobe Acrobat 11.0.0.379. The details are as follows:
Test environment: Windows 7 Professional 64-bit operating system, and 4 GB memory;
Total number of PDF files: 8000;
Mode of execution: automatic execution, setting a corresponding tested file path, the number of files to be merged, a test machine, etc., merging the files in batches, and obtaining performance data in each merging process, and comparing with the data of Adobe Acrobat11.0.0.379.

Test 1: Performance Data of Merging 50 Files Each Time

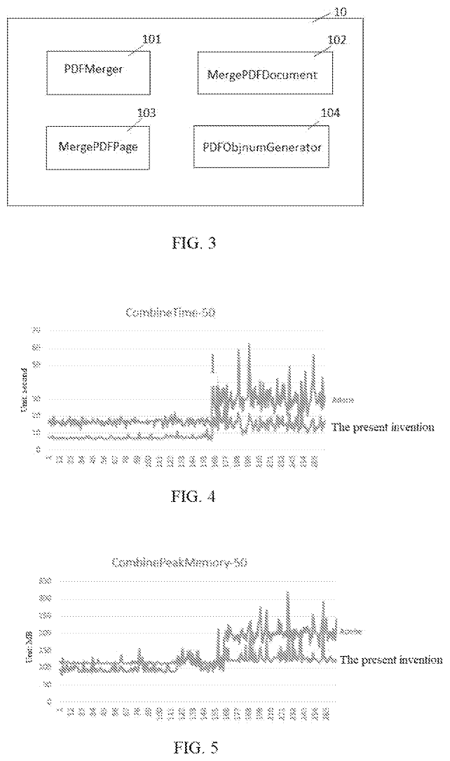

FIG. 4 is a time consumption comparison diagram of merging 50 PDF files each time according to an embodiment of the present invention, and FIG. 5 is a memory consumption comparison diagram of merging 50 PDF files each time according to an embodiment of the present invention. The horizontal axes in FIGS. 4 and 5 represent numbers of groups undergoing the merging operation, and in the present embodiment, every 50 PDF files is a group, and a total of 265 groups were merged. The vertical axes represent time consumption values and memory occupation values respectively. As shown in FIGS. 4 and 5, in the present embodiment, when merging the same 50 PDF files at a time, the average time consumption of the present invention was 11 seconds and the average memory occupation 112 MB, while the average time consumption of Adobe was 23 seconds and the average memory occupation 142 MB. The average time consumption of Adobe Acrobat was much higher than that of the present invention, and that the memory occupation was slightly higher than that of the present invention.

Test 2: Performance Data of Merging 200 Files Each Time

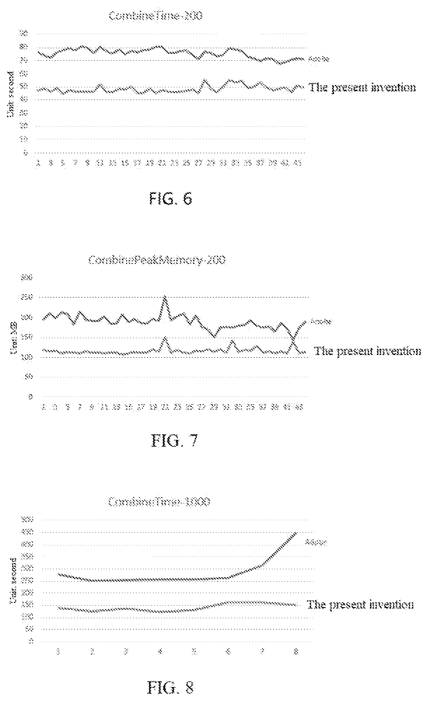

FIG. 6 is a time consumption comparison diagram of merging 200 PDF files each time according to an embodiment of the present invention, and FIG. 7 is a memory consumption comparison diagram of merging 200 PDF files each time each time according to an embodiment of the present invention. The horizontal axes in FIGS. 6 and 7 represent numbers of groups undergoing the merging operation, and in the present embodiment, every 200 PDF files is a group, and a total of 43 groups are merged. The vertical axes represent time consumption values and memory occupation values respectively. As shown in FIGS. 6 and 7, in the present embodiment, when merging the same 200 PDF files at a time, the average time consumption of the present invention was 48 seconds and the average memory occupation 116 MB, while the average time consumption of Adobe was 75 seconds and the average memory occupation 189 MB, indicating that both the average time consumption and memory occupation of Adobe Acrobat were higher than those of the present invention.

Test 3: Performance Data of Merging 1000. Files Each Time

FIG. 8 is a time consumption comparison diagram of merging 1000 PDF files each time according to an embodiment of the present invention, and FIG. 9 is a memory consumption comparison diagram of merging 1000 PDF files each time according to an embodiment of the present invention. The horizontal axes in FIGS. 8 and 9 represent numbers of groups undergoing the merging operation, and in the present embodiment, every 1000 PDF files is a group, a total of 8 groups were merged. The vertical axes represent time consumption values and memory occupation values respectively. As shown in FIGS. 8 and 9, in the present embodiment, when merging the same 1000 PDF file at a time, the average time consumption of the present invention was 140 seconds and the average memory occupation 124 MB, while the average time consumption of Adobe was 291 seconds and the average memory occupation 204 MB, indicating that both the average time consumption and memory occupation of Adobe Acrobat were much higher than those of the present invention.

Test 4: Performance Data of Merging 2000. Files Each Time

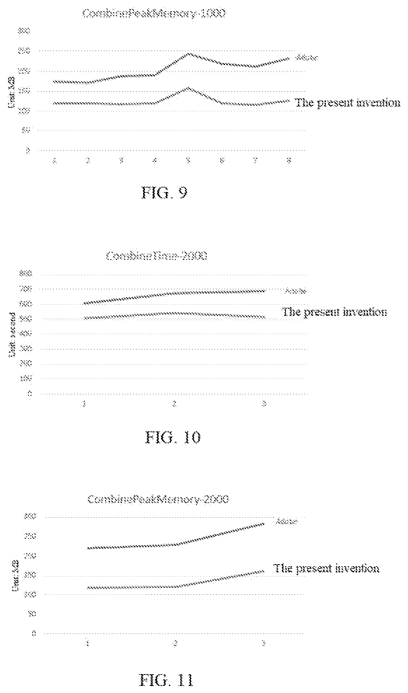

FIG. 10 is a time consumption comparison diagram of merging 2000 PDF files each time according to an embodiment of the present invention, and FIG. 11 is a memory consumption comparison diagram of merging 2000 PDF files each time according to an embodiment of the present invention. The horizontal axes in FIGS. 10 and 11 represent numbers of groups undergoing the merging operation, and in the present embodiment, every 2000 PDF files is a group, and a total of 3 groups were merged. The vertical axes represent time consumption values and memory occupation values respectively. As shown in FIGS. 10 and 11, in the present embodiment, when merging the same 2000 PDF files at a time, the average time consumption of the present invention was 521 seconds and the average memory occupation 133 MB, while the average time consumption of Adobe was 657 seconds and the average memory occupation 244 MB, indicating that the average time consumption of Adobe Acrobat was slightly higher than that of the present invention, but the average memory occupation of Adobe Acrobat was much higher than that of the present invention.

Therefore, the present invention is good in operation time consumption and relatively stable in memory occupation when merging different numbers of PDF files. In comparison with the performance data of Adobe Acrobat, it can be seen that the present invention is superior to Adobe Acrobat in terms of time consumption and memory occupation.

Compared with the prior art, the method and system for merging PDF files in a large batch provided the present invention have the following advantages: during the merging of PDF files in a large batch, the merging time is shorter, the whole process occupies little system memory, the merging efficiency is higher, and the merging operation does not affect the use of other applications.

It should be understood by those skilled in the art that the accompanying drawings are merely schematic diagrams of an embodiment, and the modules or processes in the accompanying drawings are not necessarily necessary for the implementation of the present invention.

Those skilled in the art should understand that the modules in the device in the embodiment may be distributed in the device in the embodiment according to the description of the embodiment, and may also be located in one or more devices different from this embodiment according to corresponding changes. The modules in the aforementioned embodiments may be combined into one module, or may be further divided into a plurality of sub-modules.

Finally, it should be noted that, the above embodiments are only used to illustrate the technical solutions of the present invention, but should not limit the same; although the present invention is described in detail with reference to the embodiments described above, it will be understood by those skilled in the art that, the technical solutions in the embodiments described above can still be modified, or some of the technical features can be equivalently replaced; and these modifications or replacements do not make the technical solutions corresponding thereto depart from the spirit and scope of the technical solution in the embodiments of the present invention.

1. A method for merging PDF files in a large batch, comprising the following steps:
Step 1: determining and outputting header information of a merged target PDF file, outputting corresponding catalog dictionary information, and generating and recording objnums (object numbers) of corresponding PDF pages;
Step 2: sequentially parsing a plurality of PDF files to be merged to obtain objnums and offsets of all indirect objects of each PDF file to be merged as well as catalog dictionary information of each PDF file to be merged;
Step 3: sequentially parsing page dictionary information corresponding to each PDF file to be merged from the catalog dictionary information of the PDF file to be merged, and sequentially reading the objnum information of each page from all the page dictionary information;
Step 4: calling a global objnum generator to generate new objnums, and recording the corresponding relationship between the original objnum information and the new objnums into a map;
Step 5: calling an output class for the PDF indirect objects to output the pages of each PDF file to be merged into pages of the merged target PDF file, and recording their starting positions and lengths in the target PDF file;
Step 6: checking whether all the PDF files to be merged have been merged,
if not, returning to Step 2;
if so, combining global information into the merged target PDF file according to page dictionary information of the target PDF file.

2. The method according to claim 1, wherein the information parsed from the catalog dictionary information of each PDF file to be merged in Step 3 further comprises AcroForm information and bookmark information corresponding to the PDF file to be merged.

3. The method according to claim 1, wherein Step 5 specifically comprises:
Step 501: storing all the indirect objects referenced in the page dictionary information of each PDF file to be merged into a vector;
Step 502: circularly outputting all the indirect objects in the vector into the merged target PDF file, and if any output is a parent dictionary of the pages of the PDF file to be merged, using a page of the target PDF file to replace and end the corresponding output;
Step 503: judging whether all the indirect objects have been output,
if so, arranging the page dictionary information of each PDF file to be merged, and recording starting positions and lengths of all the indirect objects in the vector in the merged target PDF file;
if not, returning to Step 3.

4. The method according to claim 3, wherein in Step 501, the indirect objects of the parent of the pages of each PDF file to be merged are modified into the pages of the merged target PDF file when stored.

5. The method according to claim 3, wherein the output of any indirect object in Step 502 is performed only once.

6. The method of claim 1, wherein the global information combined in Step 6 comprises AcroForm information and bookmark information.

7. A system for merging PDF files in a large batch, configured to implement the method of claim 1, and comprising:
a PDFMerger module, configured to manage a merged target PDF file, which comprises objnums of all indirect objects output in the process of PDF merging, offsets of all the indirect objects, and page dictionary information of the target PDF file;
a MergePDFDocument module, configured to manage and parse the PDF files to be merged, and parsed contents comprising the objnums and offsets of all the indirect objects, catalog dictionary information of the PDF files to be merged, all the page dictionary information and AcroForm dictionary information;
a MergePDFPage module, configured to process all the indirect objects to be output in the page dictionaries of the PDF files to be merged; and
a PDFObjnumGenerator module, configured to generate objnums of the indirect objects of the merged target PDF file, and being a global-oriented class module.
